(19) United States
(12) Patent Application Publication
(10) Pub. No.: US 2024/0105149 A1
(43) Pub. Date: Mar. 28, 2024

(54) DRUM WITH A TUNING MECHANISM

(71) Applicant: Elwyn J. Hancox, Winnipeg (CA)

(72) Inventor: Elwyn J. Hancox, Winnipeg (CA)

(21) Appl. No.: 18/468,119

(22) Filed: Sep. 15, 2023

Related U.S. Application Data
(60) Provisional application No. 63/410,271, filed on Sep. 27, 2022.

(51) Int. Cl. G10D 13/16; G10D 13/02; G10D 13/10; G10D 13/20

(52) U.S. Cl. CPC G10D 13/16; G10D 13/02; G10D 13/20; G10D 13/25

(57) ABSTRACT

Two or more deadening elements are in contact with the underside of the drum head and are provided with a mechanism which moves the deadener or deadeners across the drum head thus varying the effective resonating area of the head so that the drum can be tuned while playing. As an example, the drum tuning can be changed from a bass drum to a concert tom. The preferred embodiment includes a pair of opposed, curved deadeners which are moved towards and away from one another in concentric relationship with the drum head. The actuator system is arranged to move the first deadening element at a rate of movement different from the second and thus defining three effective resonating areas of different sizes between the first and the periphery, between the first and the second and between the second and the periphery.

This application claims the benefit under 37 CFR 1.119(e) of Provisional Application 63/410,271 filed Sep. 27, 2022.

This invention relates to new and useful improvements in tuning mechanisms for musical drums. Conventionally, such tuning is provided by the initial tightening of the skin constituting the drum head, by means of keys and adjustable bolts situated around the perimeter of the drum head.

### BACKGROUND OF THE INVENTION

Attempts have been made in the past to provide a tuning mechanism which is variable while the drum is being played and examples of such tuning mechanisms are shown in U.S. Pat. Nos. 2,729,133, 2,548,271, 3,685,389 and the mechanism shown in U.S. Pat. No. 4,048,895 which is an adaptation of the “RotaTom”. All of these patents operate by varying the tension in the drum head skin which is an unsatisfactory way of accomplishing the tuning because of the varying of tension of the skin. This tends to stretch the skin unduly and place undue strain upon the skin and considerable leverage is required in order to accomplish this skin or drum head stretching.

In prior U.S. Pat. No. 4,228,721 (Hancox) issued Oct. 21 1980 is disclosed an arrangement including two deadening elements which are in contact with the underside of the drum head and are connected to a foot operated mechanism which moves the deadener or deadeners across the drum head thus varying the effective resonating area of the head so that the drum can be tuned while playing. As an example, the drum tuning can be changed from a bass drum to a concert tom. The preferred embodiment includes a pair of opposed, curved deadeners which are moved towards and away from one another by a common pulley system in concentric relationship with the drum head so that both elements move simultaneously.

### SUMMARY OF THE INVENTION

According to the invention there is provided a musical drum comprising:
a substantially cylindrical body defining a center and a circular periphery;
a drum skin stretched over one end of the body to the periphery and constituting a drum head;
and a drum tuning mechanism comprising:
   a first and a second deadening element each in contact with the underside of the skin and each comprising a generally arcuate strip element arranged on a respective side of the center;
   a track mounting said first and second deadening elements within the body for movement toward and away from the center thereby varying an effective resonating area of the drum head;
   and an actuator system within said body operatively connected to the deadening elements to move the deadening elements across said drum head;
   the actuator system being arranged to move the first deadening element at a rate of movement different from the second and thus defining three effective resonating areas of different sizes between the first and the periphery, between the first and the second and between the second and the periphery.

Preferably each of said deadening elements includes an arcuately curved strip with one longitudinal surface thereof contacting the underside of said drum head.

Preferably the mounting track of said deadening elements within said body includes:
a track assembly spanning said body,
and track assembly engaging elements on said deadening element guiding and holding said deadening element relative to said drum head.

Preferably the track assembly is curved with the apex of the curvature being substantially centrally of said drum head.

Preferably there is provided means to adjust the deadening element relative to said drum head thereby varying the pressure of said deadening element upon said drum head.

Preferably the actuator system includes at least one linear actuator for moving the first and a second deadening element.

Preferably the actuator system includes one linear actuator for moving the first deadening element and a coupling between the first and a second deadening elements which generates movement of the second deadening element at a rate of movement different from the first.

Preferably the actuator system includes one linear actuator for moving the first deadening element and a coupling between the first and a second deadening elements which generates movement of the second deadening element at a rate of movement twice that of the first.

Preferably the coupling comprises a pulley.

Preferably the actuator system includes an arrangement for returning the second deadening element from a retracted position outwardly to an initial position adjacent the periphery.

Preferably the actuator system is arranged to move the first deadening element at a rate of movement equal to or greater than two times that of the second. The movement may be at a rate of movement of the order of three times that of the second.

The actuator system can include an operating control operable by physical contact with a body component of a player. Alternatively the actuator system can be operated based on a computer control program related to music to be played.

In one arrangement for driving the deadeners, the actuator system includes two motors each for driving a respective one of the first and second deadening elements where there is provide an electrical control system which controls the movement of the motors at different rates of movement.

The present invention thus accomplishes the tuning by varying the effective resonating area of the skin forming the drum head rather than by varying the basic tension thereof. This means that the tension of the skin or drum head remains relatively constant at all times thus relieving undue strain upon the skin. It also means that relatively simple and lightweight mechanisms can be used to accomplish this variation of resonating area. Another advantage of the present invention is that means may be provided to vary the initial contact or pressure of the deadeners upon the underside of the drum head.

A further advantage of the present invention is to provide a device of the character herewithin described in which the basic tuning of the drum head can be undertaken by the conventional means around the perimeter of the drum with the deadeners in the widest position thus enabling infinite tuning to be carried out from this point, within the range of the movement of the deadeners.

Yet another advantage of the present invention is to provide a device of the character herewithin described which is simply installed upon existing drums, is economical in manufacture and otherwise well suited to the purpose for which it is designed.

### BRIEF DESCRIPTION OF THE DRAWINGS

While the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention, in which:

FIG. 1 is a vertical cross section of a musical drum showing the deadening elements installed therein.

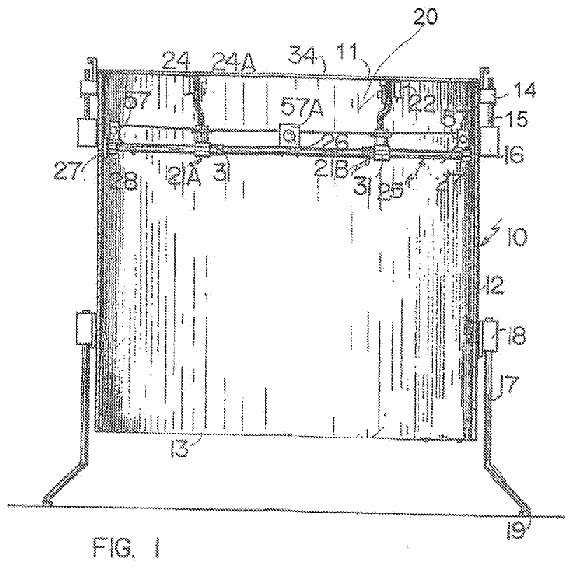

FIG. 2 is a top plan view of the mechanism within the drum body with the drum head removed for clarity to show an embodiment in which the deadening elements are driven by two separate motors electrically connected to provide the required rate of movement.

FIGS. 3 and 4 are side elevational views similar to FIG. 1 showing the deadeners in retracted and advanced positions and including a schematic illustration of an actuator mechanism using pulleys for operating movement between the two positions.

FIG. 5 is a bottom plan view of an alternative pulley arrangement using a power source to drive a first pulley which communicates the differential rate of drive to the first and second pulleys attached to the first and second deadening elements respectively.

FIG. 6 is a bottom plan view of a further alternative pulley arrangement using a power source to drive a pulley which communicates the differential rate of drive to the first and second pulleys driving two belts which are attached to the first and second deadening elements respectively. The belts include teeth to maintain synchronism.

### DETAILED DESCRIPTION

A drum collectively designated 10 is shown having a single skin 11 spanning the cylindrical body 12 at one end only with the opposite or lower end 13 being open and although the device is designed primarily for use with single headed drums, nevertheless it can be readily adapted for use with drums having opposing head assemblies.

The skin 11 is held by means of the clamp ring 14 surrounding the upper end of the drum body 12 and the initial tension of the skin is adjusted by a plurality of bolt assemblies 15 cooperating between the ring 14 and anchors 16 secured to the side wall of the drum, all of which is conventional.

Also to be noted are the tripod leg assemblies consisting of three individual leg members 17 engaging within leg holders 18 secured to the drum body 12 and extending downwardly therefrom terminating in rubber tipped lower ends 19, once again all of which is conventional.

The arrangement herein collectively designated 20 is situated within the drum body 12 and is secured thereto as will hereinafter be described.

In its preferred embodiment, the invention includes first and second deadening elements 21A and 21B.

Each deadening element consists preferably of an arcuately curved member 22, 24 secured to a mounting strip 23 by means of rivet screws or the like (not illustrated) with the mounting strip 23 in turn being secured to a cylindrical socket 24A as by welding or the like. The deadening members 22 are provided with a curvature similar to the curvature of the drum head and these elements are preferably formed from lead or a similar material and are positioned so that the upper longitudinally extending edge 24 contacts the underside of the skin 11 which constitutes the drum head. Lead or some similar substance is preferred as it gives the required deadening effect. Felt can be used, but it is found that felt gives a completely dead feeling whereas lead or some similar relatively heavy material, not only gives the required deadening effect, but also provides the desired amount of “hangover” when the drums are being played.

A rail assembly collectively designated 25 spans the body 12 of the drum just below the drum head or skin 11 and is preferably slightly arcuately curved with the apex 26 of the rail assembly being situated substantially centrally of the drum head 11. This ensures that the deadening elements are maintained in contact with the drum skin bearing in mind that the drum skin is more flexible adjacent the center than at the sides.

In the present embodiment, the rail assembly comprises a pair of spaced and parallel cylindrical rods 25A, the ends of which engage within sockets 27 which in turn are secured to the wall of the drum body 12 by means of screws 28 or the like.

The aforementioned deadener elements include a short, angulated rod 29 engaging within the socket 24A so that the element 22 may be raised or lowered relative to the drum head 11 and secured in the desired relationship by means of a set screw or Allen screw engaging through the wall of the socket 24A. This enables the edge 24 of the deadener element 22 to contact the underside of the head or skin 11 with the desired amount of pressure depending upon circumstances.

The lower end of an angulated rod is screw threaded and engages within a mounting block 31 so that it extends upwardly from the upper side thereof. This mounting block is apertured to slidably engage over the twin rails 25A constituting the part of the rail assembly 25 so that the two deadening assemblies can slide along the rails 25A towards or away from one another always maintaining contact with the underside of the drum head or skin 11.

It will be noted that the deadening elements are situated concentrically with the perimeter of the drum and one upon each side of the centre point of the drum head so that as they move towards or away from one another, they define therebetween, a resonating area indicated by reference character 34. The slight curvature of the rails is desirable as it assists in maintaining an even tension on the drum head or skin regardless of the position of the elements 21.

An actuator is provided to move the elements 21 towards or away from one another by the desired amount, said means including a guide track collectively designated as described in a number of different embodiments hereinafter.

and an actuating rod collectively designated 36 with flexible cord assembly collectively designated 37 being operatively connected between the elements 21 and the actuating rod 36.

The guide track, in this embodiment, includes a pair of spaced and parallel rods extending downwardly from one of the tracks approximately centrally thereof. In other arrangements not shown the guide track can comprises a flat bar with an upwardly facing flat surface over which the deadener element can roll using rollers or wheels to reduce friction forces. A holder abutment on the deadener element can engage the flat bar at the underside to hold the structure in stable position as it moves along the guide.

In operation, the deadening elements 21 are moved to their furthest apart position whereupon the initial tension drum head or skin 11 is set by means of the assemblies 15.

Once tuned to this basic tension, the tuning can be varied at will by moving the deadener elements 22 towards one another thereby varying the effective resonance area of the skin 11 and at the same time maintaining a substantially even tension to the skin or drum head 11.

Although the rail assembly 25 is shown with two cylindrical cross sectioned rods, nevertheless it will be appreciated that other configurations can be used provided that the deadening elements are prevented from rotating relative to the rail assembly.

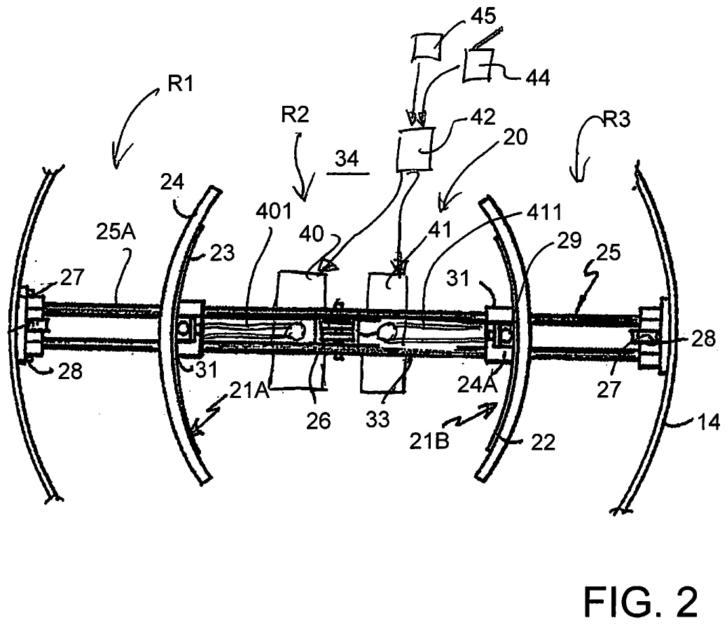

In FIG. 2, the actuator system 20 includes two motors 40 and 41 each for driving a respective one of the first and second deadening elements 23 through a respective belt 401, 411 and there is provide an electrical control system 42 which controls the drive movement of the motors at different rates of movement. In this arrangement the actuator system defined by the motors is arranged to move the first deadening element 22 at a rate of movement equal to or greater than two times that of the second element 24. More preferably the actuator system is arranged to move the first deadening element 22 at a rate of movement of the order of three times that of the second 24.

In this arrangement, the actuator system 20 is arranged to move the first deadening element 22 at a rate of movement different from the second 24 and thus defining three effective resonating areas R1, R2 and R3 of different sizes including a first R1 between the first and the periphery, a second R2 between the first and the second and a third R3 between the second and the periphery.

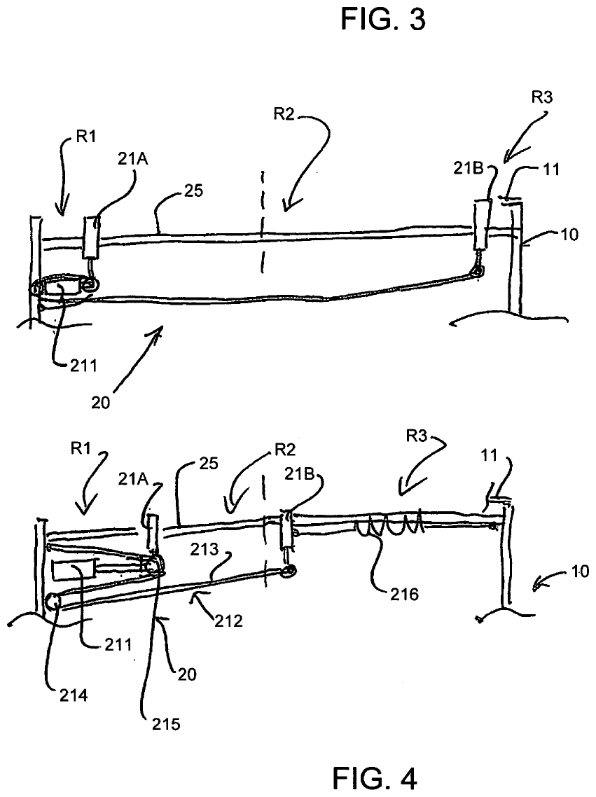

In FIGS. 3 and 4 is shown an actuator system 20 within the body operatively connected to the deadening elements 21A, 21B to move the deadening elements across the drum head.

As explained above, each of the deadening elements includes an arcuately curved strip with one longitudinal surface thereof contacting the underside of the drum head.

As explained above, the mounting of said deadening elements within said body includes a track or rail assembly 25 spanning the body and track engaging elements 21A, 21B on the track guiding and holding the deadening elements relative to the drum head.

As explained above, the track assembly 25 is curved with the apex of the curvature being substantially centrally of said drum head.

As explained above, the elements 31 include an adjustment component to adjust the height of the deadening element relative to the drum head thereby varying the pressure of the deadening element upon the drum head.

In this arrangement, the actuator system 20 includes a linear actuator 211 for moving the first deadening element 21A along the guide track 25. There is also provided a coupling 212 between the first element 21A and the second deadening element 21B which generates movement of the second deadening element at a rate of movement different from the first. Typically the rate of movement is proportional and in an arrangement where the second moves at a rate equal to or more than twice the rate of the first, this can be carried out by a simple pulley construction including a cable 213 attached at one end to the drum and at the other end to the second element 21B and passing over pulley wheels 214 and 215 where the latter is mounted on the element 21A so that the cable and pulley arrangement pulls the element 21B at twice the rate of the element 21A. Other arrangements for carrying out the same function can be provided where the ratio of movement is obtained by the selection of the device. The same operation can be obtained by using two linear actuators or two motors each moving a separate one of the elements.

In the arrangement where the element is pulled by a cable or wire, the actuator system includes an arrangement such as a spring 216 for returning the second deadening element from a retracted position shown in FIG. 4 outwardly to an initial position adjacent the periphery shown in FIG. 3.

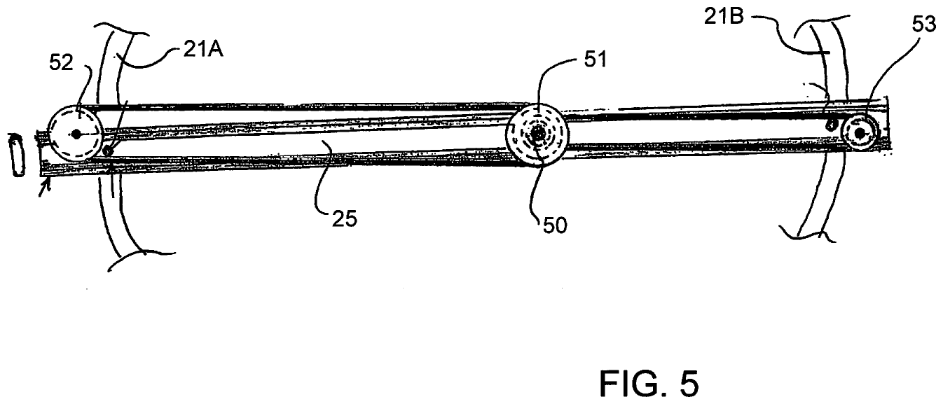

FIG. 5 is a bottom plan view of an alternative pulley arrangement using a power source 50 to drive a first pulley 51 which communicates the differential rate of drive to the first pulley 52 and to a second pulley 53 attached to the first and second deadening elements respectively where the pulleys 52 an d53 are of different diameters so provide eh different rate of movement.

It will be appreciated that the separate areas R1, R2 and R3 can be adjusted to have different sizes and thus different tunings and these sizes can be adjusted during use by operating the actuator 211 or the motor 50 or the two motors 40 and 41 using an electrical switch.

The actuator system includes an operating control 44 operable by physical contact with a body component of a player to control the actuators as required to allow the player to effect the required movement during playing to change the tuning.

Alternatively the actuator system can be operated based on a computer control program from an input 45 related to music to be played. Thus the actuator or actuators can be operated by the computer-controlled system including programing to effect tuning at intervals and times determined by the program. This avoids the necessity for the drummer to effect the control and can be used as a part of a pre-programmed music effects system which generates additional musical components for a performance.

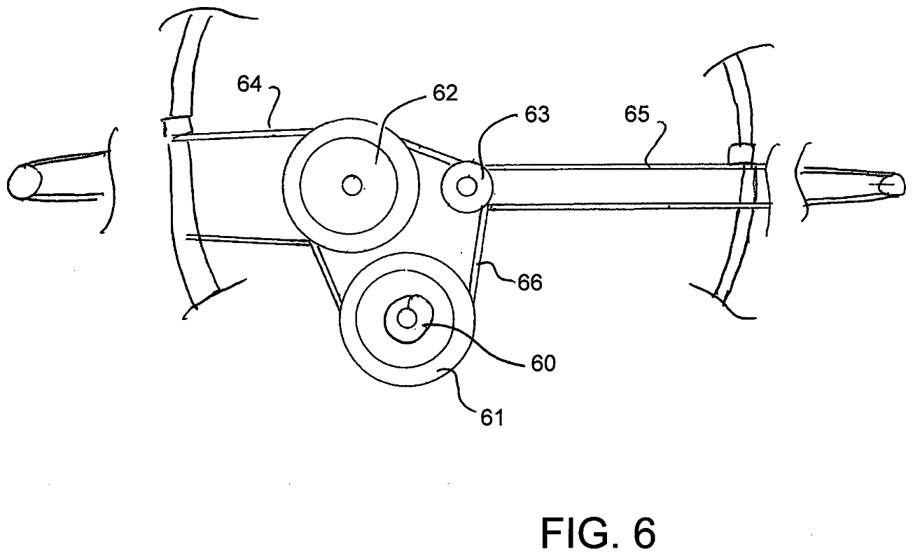

FIG. 6 is a bottom plan view of a further alternative pulley arrangement which operates similarly to that of FIG. 5 using a power source 60 to drive a pulley 61 which communicates though a belt 66 to two pulleys 62 and 63 of different diameters so that the belt 66 drives the pulleys 62 and 63 at a common rate which is connected to respective belts 64 and 65 so that the different diameters drive the belts 64 and 65 at differential rates so as to move the deadeners 21A and 21B at different rates. The pulleys are stacked as required to provide the necessary driving toothed wheels to the belts.

Since various modifications can be made in my invention as hereinabove described, and many apparently widely different embodiments of same made within the spirit and scope of the claims without departing from such spirit and scope, it is intended that all matter contained in the accompanying specification shall be interpreted as illustrative only and not in a limiting sense.

1. A musical drum comprising:
a substantially cylindrical body defining a center and a circular periphery;
a drum skin stretched over one end of the body to the periphery and constituting a drum head;
and a drum tuning mechanism comprising:
a first and a second deadening element each in contact with the underside of the skin and each comprising a generally arcuate strip element arranged on a respective side of the center;
a track mounting said first and second deadening elements within the body for movement toward and away from the center thereby varying an effective resonating area of the drum head;
and an actuator system within said body operatively connected to the deadening elements to move the deadening elements across said drum head;
the actuator system being arranged to move the first deadening element at a rate of movement different from the second and thus defining three effective resonating areas of different sizes between the first and the periphery, between the first and the second and between the second and the periphery.

2. The musical drum according to claim 1 in which each of said deadening elements includes an arcuately curved strip with one longitudinal surface thereof contacting the underside of said drum head.

3. The musical drum according to claim 1 wherein the mounting track of said deadening elements within said body includes a track assembly spanning said body and track assembly engaging elements on said deadening elements guiding and holding said deadening elements relative to said drum head.

4. The musical drum according to claim 3 in which said track assembly is curved with the apex of the curvature being substantially centrally of said drum head.

5. The musical drum according to claim 1 which includes an adjust component for adjusting a height of the deadening element relative to said drum head thereby varying the pressure of said deadening element upon said drum head.

6. The musical drum according to claim 1 wherein the actuator system includes at least one linear actuator for moving the first and the second deadening elements.

7. The musical drum according to claim 1 wherein the actuator system includes one linear actuator for moving the first deadening element.

8. The musical drum according to claim 1 wherein the actuator system includes one linear actuator for moving the first deadening element and a coupling between the first and a second deadening elements which generates movement of the second deadening element at a rate of movement different from the first.

9. The musical drum according to claim 1 wherein the actuator system includes one linear actuator for moving the first deadening element and a coupling between the first and a second deadening elements which generates movement of the second deadening element at a rate of movement twice that of the first.

10. The musical drum according to claim 8 wherein the coupling comprises a pulley.

11. The musical drum according to claim 1 wherein the actuator system includes an arrangement for returning the second deadening element from a retracted position outwardly to an initial position adjacent the periphery.

12. The musical drum according to claim 1 wherein the actuator system is arranged to move the first deadening element at a rate of movement equal to or greater than two times that of the second.

13. The musical drum according to claim 1 wherein the actuator system is arranged to move the first deadening element at a rate of movement of the order of three times that of the second.

14. The musical drum according to claim 1 wherein the actuator system includes an operating control operable by physical contact with a body component of a player.

15. The musical drum according to claim 1 wherein the actuator system is operated based on a computer control program related to music to be played.

16. The musical drum according to claim 1 wherein the actuator system includes two motors each for driving a respective one of the first and second deadening elements and wherein there is provide an electrical control system which controls the movement of the motors at different rates of movement.
